(19) United States
(12) Patent Application Publication
(10) Pub. No.: US 2004/0084359 A1
(43) Pub. Date: May 6, 2004

(54) Manhole cover liquid level monitoring system

(76) Inventor: John A. Pasko, Ypsilanti, MI (US)

Correspondence Address: BAKER & DANIELS, 111 E. WAYNE STREET, SUITE 800, FORT WAYNE, IN, 46802

(21) Appl. No.: 10/618,216

(22) Filed: Jul. 11, 2003

Related U.S. Application Data
(60) Provisional application No. 60/395,154, filed on Jul. 11, 2002.

(51) Int. Cl. B01D 35/143

(52) U.S. Cl. 210/97

(57) ABSTRACT

A liquid level monitoring system for detecting high liquid levels in a wastewater handling system, includes wireless sensor modules, a wireless network, and a processor system. Individual sensor modules are battery powered and may be located at various points in the wastewater handling system, for example, at access openings such as those provided by a manhole cover. Each sensor module includes a capacitive probe, a capacitive sensing alarm circuit, and a wireless communication device. In the event the capacitive probe depending downward from the sensor module is submerged in liquid, the alarm circuit detects the high water level and activates the wireless communication device, thus transmitting an event message to the wireless network, which in turn transmits the event message to the processing system. The processing system includes a database that stores sensor module identifiers and installed sensor module locations. An event message is used to correlate the sensor module identifier with the installed sensor location and to notify a dispatch center or other notification message recipient of the high liquid level event and location.

### CROSS-REFERENCE TO RELATED APPLICATION

This application claims the benefit under Title 35, U.S.C. § 119(e) of U.S. Provisional Patent Application Serial No. 60/395,154, entitled MANHOLE COVER LIQUID LEVEL MONITORING SYSTEM, filed on Jul. 11, 2002.

### BACKGROUND

1. Field of the Invention

The present invention relates to liquid level sensors, and in particular to a system for wireless monitoring of liquid levels.

2. Description of the Related Art

Existing liquid level sensors are commonly used to detect liquid levels in tanks, reservoirs, and other closed system applications. However, such sensors do not lend themselves well to use in an open liquid handling system such as a wastewater or storm water handling system.

Some known devices use mechanical or moving parts such as mechanical switches operated by rubber diaphragms, springs, rods, floats, or balls, all of which may require adjustment and tend to wear out or malfunction over time.

Mechanical sensors may not reliably hold up to the long-term vibration and harsh environment present in a wastewater system located under or adjacent to a roadway. Vibration from passing vehicles may cause false mechanical activation of level sensors and failure of sensitive float mechanisms. The harsh environment may also present debris and corrosive liquids that will deteriorate the operation of float systems. Additionally, mechanical float systems located in the space below a manhole cover can present an obstacle to maintenance personnel accessing the space.

Other known devices use electrical or optical probes to determine the liquid level. For example, self-heating thermistors or conductivity probes may be used. However, such systems using probes may be sensitive to humidity, moisture, changing temperatures, and varying voltage levels in the sensing circuit, all of which may produce erroneous results and subject the probes to wear. Also, contamination of the probes may adversely affect their performance. The probes and their associated circuitry may be adjusted to improve performance, but making the adjustments may be inconvenient and expensive.

A power supply line for supplying power to electronic sensors and communication of high liquid levels may be difficult and expensive to install for sensors located in existing roadways or remote areas. Batteries charged by solar cells offer a solution in some applications; however, solar cells may not be a viable option for a sensor located within some systems, for example, in a wastewater system located under a roadway.

Communication of a high liquid level to a central control or dispatch location presents an additional problem. Dedicated hard wiring or proprietary radio devices are generally cost prohibitive, may require excessive transmitter power, and tie municipalities to sole service providers.

What is needed is a liquid level sensor which reliably operates without the need for adjustment or external power. Also needed is a liquid level sensor which minimizes operating problems associated with contamination and mechanical wear. A further need exists for liquid level sensing which minimizes inaccuracies associated with varying temperatures.

What also is needed is a monitoring system that is cost effective, easily installed, and does not require a dedicated communications network.

### SUMMARY OF THE INVENTION

The present invention provides a liquid level monitoring system for detecting high liquid levels in a wastewater handling system. The liquid level sensor system includes wireless sensor modules disposed in the wastewater handling system, a wireless network, a processing system, and notification messages.

Individual sensor modules may be located at various points in the wastewater handling system, for example, at access openings such as those provided by manhole covers. Each sensor module monitors the liquid level in the space below the module and, upon detection of a high liquid level, transmits an event message to the wireless network, which routes the event message to the processing system. In the exemplary embodiment, the processing system includes a database for correlating event messages with the originating sensor's location and segment of the wastewater handling system. Additionally, the processing system may produce and route a notification message, pertaining to the event, to a notification recipient, for example, maintenance dispatch personnel.

The exemplary embodiment of the wireless sensor module includes a capacitive probe, a capacitive sensing alarm circuit, and a wireless communication device. Capacitive sensing solves many of the related art's environmental sensitivity and mechanical reliability problems. Advantageously, the sensor module may be battery powered so that external electric power is not required. Thus, the sensor module can be easily mounted in locations where solar or electric power is not available, for example, on the interior surface of a manhole cover supporting ring such that the capacitive probe depends downward into the space below the manhole cover.

In the event the capacitive probe becomes submerged in liquid, the capacitive sensing alarm circuit detects the high liquid level and activates the wireless communication device, sending a sensor identifier and high liquid event message to the processing system via the wireless network.

The wireless communication device includes a processor and software for receiving inputs from the alarm circuit, monitoring events and for producing event messages and an antenna for transmitting event messages to the wireless network.

For sensor locations where the antenna can be mounted without regard to vehicular or other traffic, a conventional dipole antenna may be mounted on or adjacent to the manhole cover, a nearby pole, or another nearby installation location. For sensors mounted under a manhole cover located in a roadway, possible antenna configurations include, for example, a roadway-embedded loop antenna, an antenna embedded in a composite manhole cover, a relatively flat antenna mounted on top of the manhole cover, or a dipole antenna located adjacent the roadway.

Advantageously, the wireless network can be a preexisting terrestrial or satellite wireless network, for example, a cellular network. The wireless network receives event messages from the sensor module and retransmits them to the processing system via a communications network such as the Internet.

The processing system includes a database of sensor identifiers and the installed location of each sensor. The installed location may be registered in the database by using a WAP device, such as a cellular phone, which is held by the installer at the location of the sensor module, is able to send data to the database, and is able to determine and provide GPS coordinates or other location data. Thus, an event message received by the processing system can be correlated using the sensor identifier with the location of the high water or other detected event in the wastewater handling system. The processing system may provide a status and location report of events as well as a map indicating event locations and travel directions to the event location. The processing system may also provide this and other desirable data to the notification recipient in the form of a web page, e-mail, or other communication transmission.

One advantage of the liquid level monitoring system is that the capacitive probe arrangement is not as sensitive to vibration, debris, and other harsh environmental factors, as are mechanical devices. Another advantage of the present manhole cover liquid level sensor is that it has a low power state so that an external power source is not required and batteries only need to be replaced after a period of years or after transmission of an event message. Another advantage of the present system is that existing wireless network providers, the Internet, or other existing communications networks can be utilized for establishing communication between remotely located sensor modules, the processing system, and notification recipients.

In one form, the present invention provides a liquid level monitoring system for a wastewater or other liquid handling system, including a battery-powered sensor module capable of detecting liquid handling system events, the sensor module being associated with a segment of the liquid handling system, the sensor module including a wireless communication device having a processor and associated software enabling the communication device to detect events and determine event messages relating to at least one of liquid level and sensor module status, the communication device capable of transmitting the event messages; and a processing system receiving the event messages and producing and routing a notification message, the notification message including at least one of event location, identification of the segment, and event status.

In another form thereof, the present invention provides a battery-powered sensor module including a probe, a circuit having a detector connected to the probe and capable of detecting a high liquid level on the probe, and a wireless communication device connected to the alarm circuit and having a processor and associated software enabling the communication device to determine event messages based on output of the circuit, the event messages relating to at least one of liquid level and sensor module status, the communication device capable of transmitting the event messages.

In yet another form thereof, the present invention provides a method of monitoring the liquid level of a wastewater handling system, including the steps of installing a sensor module in a segment of the wastewater handling systems, the sensor module having a wireless communication device and a sensor circuit, registering the sensor module location and identification code in a processing system, activating power to the communication device upon the sensor circuit detecting a first high liquid level, and transmitting an event message including the sensor module identification code from the communication device to the processing system.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a block diagram of the manhole cover liquid level monitoring system in accordance with the present invention;

FIGS. 2A and 2B are block schematic diagrams of a sensor module of the liquid level system of FIG. 1;

FIG. 3 is a perspective view of an uninstalled sensor module of FIG. 2;

FIG. 4A is a top view of a manhole cover and supporting ring showing the liquid level sensor module of FIG. 2 mounted to the supporting ring;

FIG. 4B is a side view of the manhole cover and supporting ring of FIG. 4a;

FIGS. 5A and 5B are a schematic diagram of a portion of the liquid level sensor module of FIG. 2;

FIG. 6 is a flowchart of the installation and registration process of the sensor module of FIG. 2 with the liquid level system of FIG. 1;

FIGS. 7A and 7B are a flowchart of the operation of the wireless communications device of the sensor module of FIG. 2;

FIG. 8 is a plan view of a web-based status report of the manhole cover liquid level monitoring system of FIG. 1;

FIG. 9 is a plan view of a web-based status history report of the sensor module of FIG. 2;

FIG. 10 is a plan view of a web-based location map of the sensor module of FIG. 2; and

FIG. 11 is a plan view of a web-based travel directions report for the sensor module of FIG. 2.

Corresponding reference characters indicate corresponding parts throughout the several views. The exemplary embodiment of the invention illustrated herein is not to be construed as limiting the scope of the invention in any manner.

### DETAILED DESCRIPTION

The embodiments disclosed below are not intended to be exhaustive or limit the invention to the precise forms disclosed in the following detailed description. Rather, the embodiments are chosen and described so that others skilled in the art may utilize their teachings.

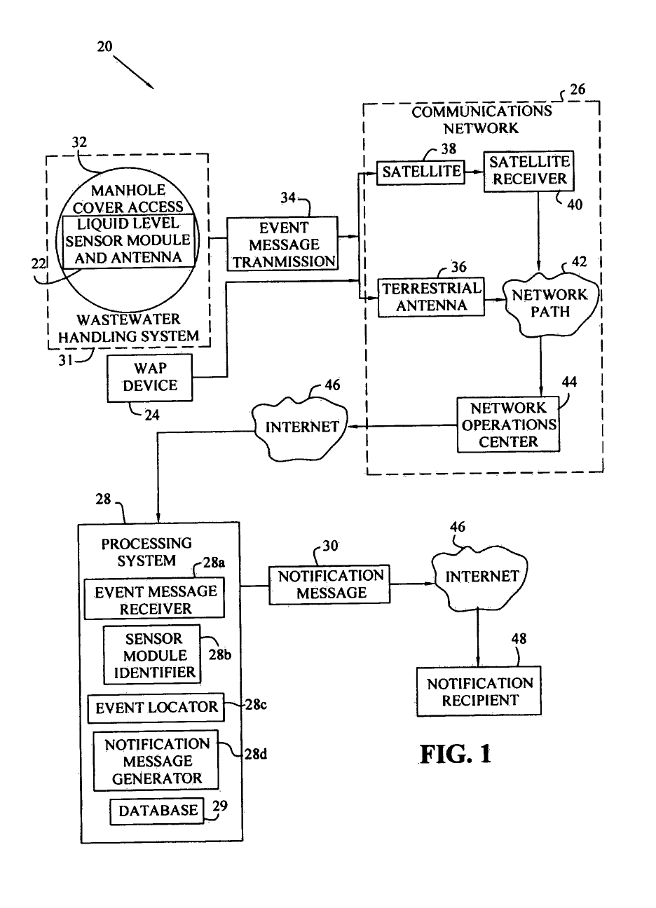

The present invention comprises a manhole cover liquid level monitoring system for wireless monitoring of the liquid level under manhole covers in a wastewater, storm water, or other material handling system. As depicted in FIG. 1, the exemplary embodiment of monitoring system 20 is capable of monitoring liquid levels in wastewater handling system 31 and generally includes liquid level sensor module 22 wireless access protocol (WAP) device 24, communications network 26, and processing system 28. Individual sensor modules 22 may be located at various segments in wastewater handling system 31, for example, at manhole cover access point 32. In the event sensor module 22 detects a high liquid level or other monitored event, event message 34 is transmitted by sensor module 22 to existing communications network 26.

Communications network 26 may include a receiving system, for example, terrestrial antenna 36 or satellite 38 and satellite receiver 40, network path 42, and network operations center 44. Event message 34 is relayed by network operations center 44 of communications network 26 to Internet 46 or another communications network or connection that transmits event message 34 to processing system 28. Processing system 28 processes event message 34 and accesses database 30, which matches event message 34 with an event location, to produce notification message 30. Notification message 30 relates to the sensed event and may be transmitted through Internet 46 or another communications network or connection to notification recipient 48, such as a maintenance dispatch personnel.

Processing system 28 includes hardware and software for processing event messages 34 and producing notification messages 30. Event message receiver 28a receives event messages 34 communicated by sensor module 22. Sensor module identifier 28b identifies the particular sensor module 22 which transmitted event message 34, for example based on an identifying code included in event message 34. Event locator 28c determines the location of sensor module 22 including the segment of waste water handling system 31 to which event message 34 pertains. For example, event locator 28c may use the sensor module identifying code and data base 29 to determine the installed location in segment. Notification message generator 28d generates notification message 30 based upon received event message 34, the determined event location, and other pre-determined parameters as programmed and specified by data base 29.

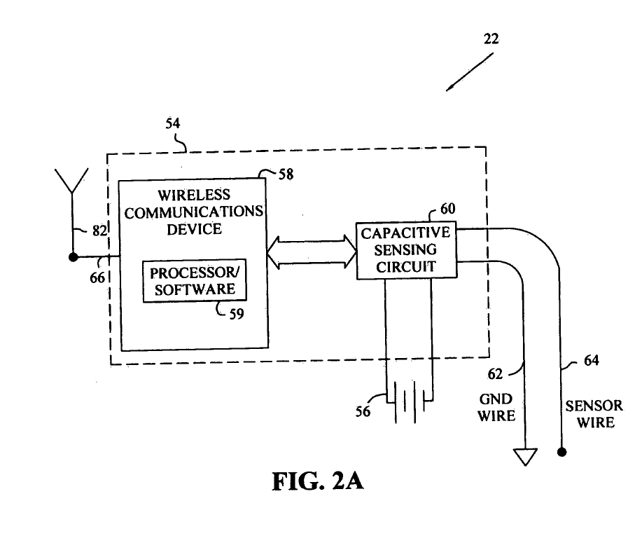

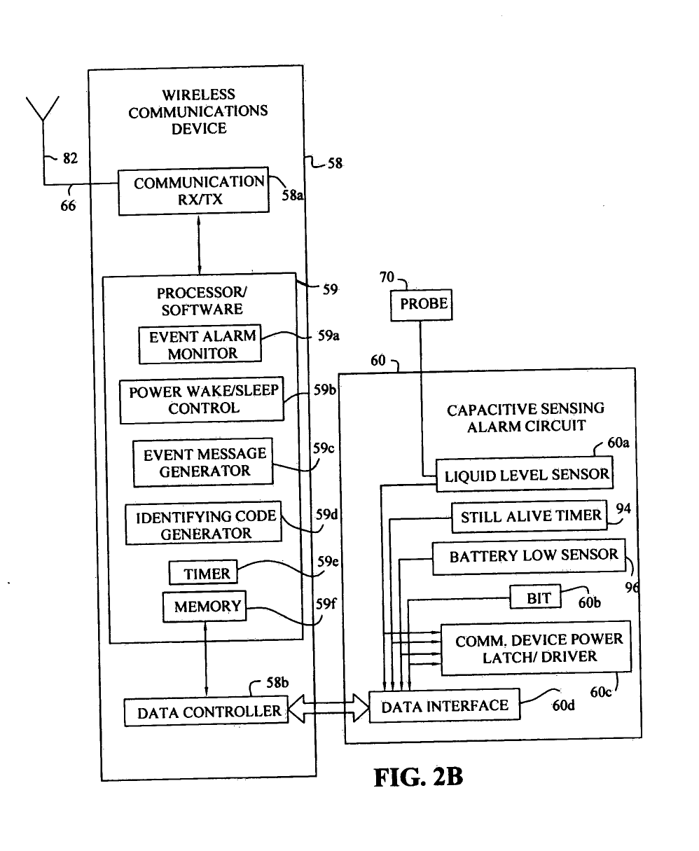

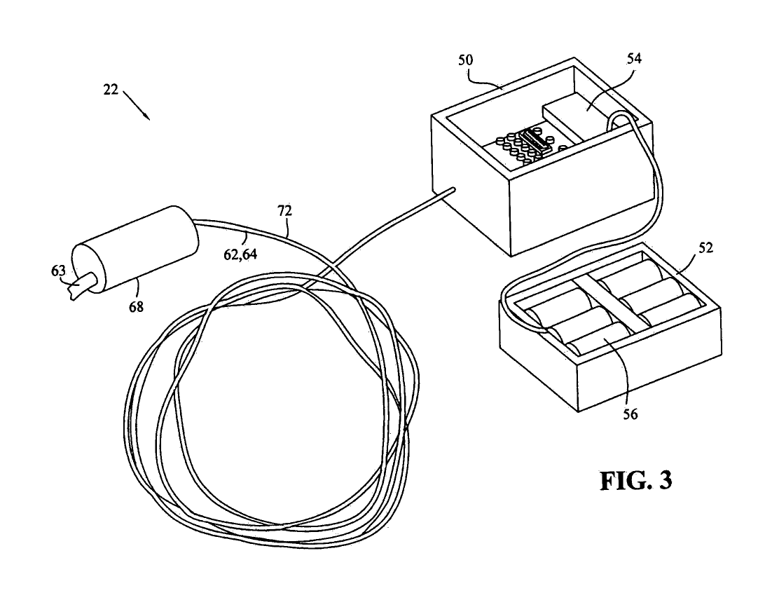

Referring now to FIGS. 2A and 3, an exemplary embodiment of sensor module 22 includes enclosure 50 and cover 52 for sealably enclosing circuit board 54 and battery 56. Circuit board 54 includes capacitive sensing alarm circuit 60 and wireless communication device 58. Alternatively, alarm circuit 60 may be separately disposed from wireless communications device 58, for example, communication device 58 may be disposed on a separate circuit board or in a separate enclosure. Communication device 58 may be, for example, a wireless modem capable of transmitting event message 34 upon alarm circuit 60 detecting a high liquid level or other event in wastewater handling system 31.

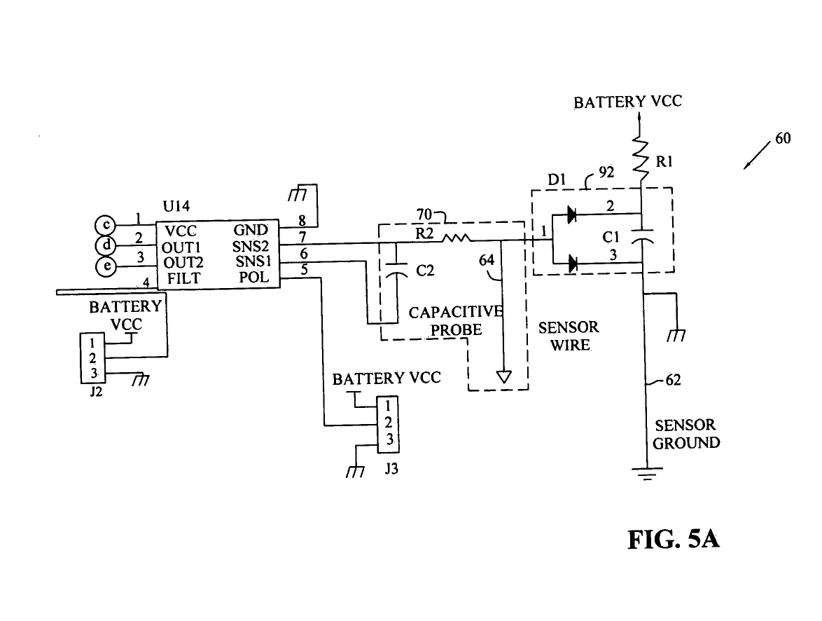

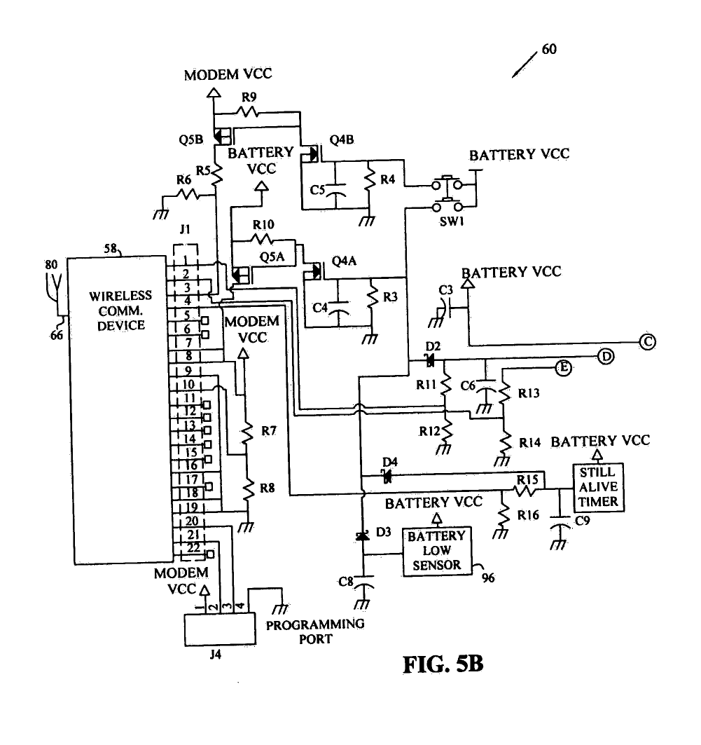

Extending from circuit board 54 and sealably protruding through enclosure 50 are ground wire 62, sensor wire 64, and antenna cable 66 (FIG. 2A). Ground wire 62 and sensor wire 64 may include weight 68 on the distant end to support extension of the wires 62 and 64 below sensor module 22. In the exemplary embodiment, ground wire 62 includes at least one portion of exposed wire 63 to provide reliable grounding with the liquid being sensed. Sensor wire 64 is an element of capacitive probe 70 (FIG. 5) and sensor wire 64 is, therefore, fully insulated by dielectric 72. For example, sensor wire 64 may be an insulated wire which also has its distant end sealably and dielectrically encapsulated.

Ground wire 62 and/or sensor wire 64 may also comprise other configurations. For example, ground wire 62 and sensor wire 64 may comprise circuit traces disposed on a portion of circuit board 54 which sealably protrudes through enclosure 50 and cover 52. Similar to the exemplary embodiment above, the circuit trace defining sensor wire 64 is sealed from the liquid being detected, while the circuit trace defining ground wire 62 is exposed. Ground wire 62 and sensor wire 64 may also be an insulated two conductor cable, having portion 63 of ground wire 62 exposed, while sensor wire 64 is encapsulated, for example, as shown in FIG. 3. Weight 68 may seal the distal end of sensor wire 64. Weight 68 may also have a conductive portion in contact with ground wire 62.

Exemplary sensor module 22 is sealed by enclosure 50 and cover 52 and may be otherwise designed to resist exposure of circuit elements to liquid and the surrounding elements in order to satisfy hazardous location standards for electronic devices. Such standards may include, for example, those developed by Underwriters Laboratories, Inc.

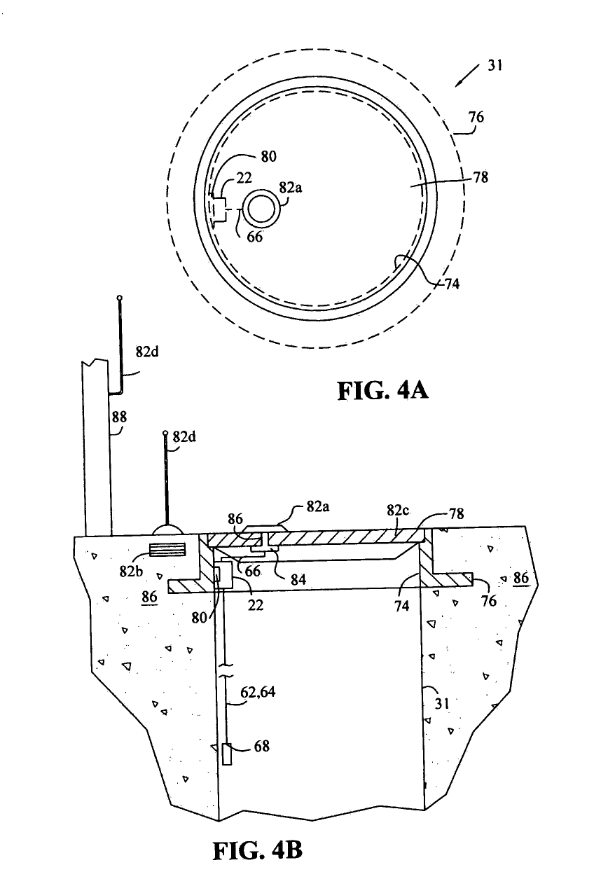

Referring now to FIGS. 4A and 4B, the exemplary embodiment of monitoring system 20 includes sensor module 22 mounted, for example, by fasteners 80, to interior wall 74 of manhole supporting ring 76. Thus, sensor module 22 is located below manhole cover 78 and is positioned so that ground wire 62 and sensor wire 64 may extend downward into the opening into wastewater handling system 31 below manhole cover 78. Depending on the desired distance below manhole cover 78 at which a high liquid level is desired to be sensed, ground wire 62 and sensor wire 64 may extend a few inches below sensor module 22 or many feet. Alternatively, sensor module 22 may be located at another portion of wastewater handling system 31, for example, a drain, vent, or clean-out element.

Wireless communication device 58 (FIG. 2A) transmits event messages via antenna cable 66 and antenna 82. Though many antenna configurations are possible, the exemplary embodiment may include one of several alternative antennas, as shown in FIG. 4B. Manhole cover mounted antenna 82a extends only slightly above manhole cover 78 and endures loads applied by vehicular or other traffic. Antenna 82a includes antenna cable connector 84 extending through clearance hole 86 defined through manhole cover 78. Such a cover mounted antenna is, for example, Model #ANT-ML860 available from Optimum Instruments, Inc., Edmonton, AB, Canada.

Also able to withstand vehicular traffic, road loop antenna 82b, such as is available from AXCESS, Inc., Carrollton, Tex., may be buried in roadway 86 adjacent to manhole cover supporting ring 76. Also capable of enduring vehicular traffic, manhole cover 78 can be replaced with a composite manhole cover that includes embedded antenna 82c, such as those available from Elan Industries, Hickory Hills, Ill. Additionally, if manhole cover 78 is in a remote location or if vehicular traffic is not a concern, a conventional dipole antenna 82d mounted adjacent manhole cover 78 or on pole 88 may be used to support transmission of event message 34. In any event, antenna 82 is selected for compatibility with communications network 26 and communication device 58.

In the exemplary embodiment, electric power for wireless communication device 58 and capacitive sensing alarm circuit 60 is provided by battery 56; however, other sources, for example solar power, could be used. Alarm circuit 60 has a low power requirement and wireless communication device 20 is typically unpowered until activated by alarm circuit 60. Therefore, alkaline, lithium, or other long-lasting batteries can provide sufficient power to support the operation of sensor module 22 for several years.

Referring now to FIG. 2B, in the exemplary embodiment, wireless communication device 58 includes communication receiver/transmitter 58a, which is coupled to antenna cable 66 and antenna 82, processor/software 59, and data controller 58b, which receives inputs and modem supply Vcc for powering communication device 58 from data interface 60d of capacitive sensing alarm circuit 60. Capacitive sensing alarm circuit 60 may include liquid level sensor 60a, which is coupled to probe 70, still alive timer 94, battery low sensor 96, built-in test (BIT) device 60b, communication device power latch and driver 60c, and data interface 60e.

Liquid level sensor 60a is capable of detecting a high and low liquid levels on probe 70, and producing an output signal which is receivable by power latch and driver 60c and data interface 60d. Still alive timer 94 produces an output signal upon a predetermined timer interval, the output signal receivable by latch and driver 60c and data interface 60d. Battery low sensor 96 monitors battery 56 and produces an output signal upon battery power dropping below a pre-determined level. The output signal from battery low sensor 96 is receivable by latch and driver 60c. BIT device 60b is capable of receiving an operator signal and initiating a BIT test. BIT device 60b produces an output signal receivable by power latch and driver 60c and data interface 60d. Communication device power latch and driver 60c and data interface 60d. Communication device power latch and driver 60c produces modem supply Vcc for powering communication device 58 upon latch and driver 60c receiving an input signal from liquid level sensor 60a, still alive timer 94, battery low sensor 96, or BIT device 60b. Latch and driver 60c driven modem supply Vcc continues for a pre-determined interval upon termination of the input signals.

Processor and software 59 receive signals from alarm circuit 60 via data interface 60d and data controller 58b. Although in the exemplary embodiment, the various aspects of processor and software 59 are implemented by software, the aspects may also be implemented by hardware or a combination of hardware and software. Event alarm monitor 59a is activated upon receiving a signal from alarm circuit 60. Upon receiving the signal, event alarm monitor 59a activates power/wake/sleep control 59b to wake communication device 58 from a low power state. Power/wake/sleep control 59b also monitors modem supply Vcc for a low battery condition.

Event message generator 59c generates event message 34 depending upon predetermined programming, parameters stored in memory 59f, input signals received from alarm circuit 60 and processing system 28, via communication receiver transmitter 58a, and input from power/wake/sleep control 59b. Additionally, event message generator 59c may incorporate an identifying code for sensor module 22, which is received from identifying code generator 59d. Timer 59e may be used for waking wireless communication device 58d on a pre-determined periodic interval in order to perform a pre-determined function, for example, transmitting a pre-determined event message. Power/wake/sleep control 59b may also place communication's device 58 in a low power sleep state upon expiration of a pre-determined timer interval received from timer 59e, the timer interval being reset each time an input signal state received by data controller 58b changes.

Referring now to FIGS. 5A and 5B, exemplary alarm circuit 60 includes capacitive probe 70 and charge transfer sensor U14 for detecting the liquid level rising below sensor module 22. Capacitive probe 70 includes sensor wire 64, reference capacitor C2, and resistor R2. Capacitor C2 and resistor R2 values are selected based on the requirements of sensor U14 and the characteristics of sensor wire 64 and dielectric 72, including wire gauge and length, and dielectric thickness.

Dielectric 72 sealably encases sensor wire 64 so that a charge may develop between sensor wire 64 and the liquid being detected, which is in electrical contact with sensor ground 62. Sensor wire 64 receives and transmits a charge that varies depending on the length of sensor wire 64 that is covered by liquid. Thus, by charging probe 70 to a fixed potential, then transferring and measuring the charge held by probe 70, charge transfer sensor U14 can accurately detect the liquid level, including two different high liquid levels and a low liquid level.

Probe 70 is charged by battery 90 through resistor R1, which is selected to reduce voltage transients, and through electrostatic discharge protection network 92, which includes diode pair D1 and capacitor C1, which are connected to sensor ground wire 62. Sensor wire 64 is also connected through resistor R2 to sense input 2 at pin 7 of sensor U14. Reference capacitor C2 is connected across sense input 2 at pin 7 and sense input 1 at pin 6 of sensor U14.

A slosh/sensitivity filter of sensor U14 can be selected by connecting pin 2 to supply V_{CC} of battery 90 at pins 1 and 2 of connector J2. Alternatively, connecting pin 2 of connector J2 to ground at pin 3 of connector J2 deselects the slosh/sensitivity filter sensor U14. The output polarity of sensor U14 is selected by connecting pin 2 of connector J3 to battery supply V_{CC} at pin 1 of connector J3 for active high output, or to pin 3 of connector J3 for active low output. Output active high is selected for the exemplary embodiment. Thus, output 1 at pin 2 of sensor U14 is driven to a high level when a predetermined first high liquid level is detected on sensor wire 64. Capacitor C6 connected to output 1 of sensor U14 eliminates a diagnostic pulse output that is characteristic of charge transfer sensor U14 used in the exemplary embodiment.

In the exemplary embodiment, sensor U14 is configured to provide output 1 upon detecting a predetermined first high liquid level on probe 70. Referring to FIG. 5B, the resistor network including R11 and R12 provides inactive pull-down for active high output 1 of sensor U14, and the junction of resistors R11 and R12 provides an output status line to pin 1 of connector J1, which is monitored by communication device 58.

A high state of output 1 of sensor U14 provides a supply current to the gate of MOSFET Q4A. Additionally, output 1 of sensor U14 charges timer circuit capacitor C4 and resistor R3, thus latching Q4A on, irregardless of the subsequent state of output 1, for a delay period of time determined by the values of capacitor C4 and resistor R3. MOSFET Q4A provides a drain to ground for the gate of MOSFET Q5A. Thus, normally high resistor R10 connected from supply V_{CC} to the gate of MOSFET Q5A is pulled to ground, switching supply V_{CC} through MOSFET Q5A to connector J1 pins 7 and 8 and to the resistor network consisting of resistors R7 and R8. Connector J1 pins 7 and 8 are also connected to modem power supply V_{CC} for communication device 58, thus providing power so that communication device 58 may detect inputs from alarm circuit 60 and transmit event message 34. Voltage divider R7 and R8 provide 3.3 volts to pin 10 of J1, switching communication device 58 from a low-power “sleep” state to a high-power transmitting state. Pins 9 and 18 of J1 provide the circuit ground to communication device 58.

Output 2 at pin 3 of sensor U14 may be coupled through resistor R13 and across resistor R14 and capacitor C7 to pin 2 of connector J1, which is also monitored by communication device 58. Output 2 may be configured to provide an active high output upon sensor U14 detecting a predetermined second high liquid level on probe 70. The second high liquid level is selected to represent a higher liquid level in wastewater handling system 31 than the first high liquid level indicated by output 1 of sensor U14.

Upon the liquid in which probe 70 is immersed falling below the first high liquid level, output 1 of sensor U14 returns to a low state and timer delay capacitor C4 is discharged. After capacitor C4 is discharged through resistor R3, MOSFET Q4A no longer provides a drain to ground and the gate for MOSFET Q5A returns to source V_{CC} turning off MOSFET Q5A and thus terminating the voltage supply V_{CC} to communication device 58. However, the timer delay is of sufficient length for communication device 58 to detect and transmit a message regarding the low liquid level as indicated by both output 1 and 2 of sensor U14 returning to a low state.

Capacitive sensing alarm circuit 60 also provides a sensor module built-in test (BIT) function and event. Upon pressing switch SW1, two circuits are energized—MOSFET Q4A and MOSFET Q5A as previously described, and MOSFET Q4B and MOSFET QSB. In order to protect output 1 at pin 2 of sensor U14 from a reverse current when switch SW1 provides battery supply V_{CC} to MOSFET Q4A, the Schottky diode D2 anode is connected to output 1, pin 2 of sensor U14 and the cathode of diode D2 to the gate of MOSFET Q4A, which is supplied with battery supply V_{CC} upon test switch SW1 being engaged. Thus, activating test switch SW1 provides a signal to the same communication device 58 connector pins (7, 8) as does sensing a high liquid level on sensor wire 33 and also provides a BIT signal to connector pin 3 of communication device 58.

The BIT signal is provided by MOSFET Q4B and latch timer components capacitor C5 and R4, and MOSFET Q5B and resistor R9 in much the same fashion as a high liquid level signal from output 1 of U14 is provided by MOSFET Q4A and Q5A. MOSFET Q5B provides modem supply V_{CC} to communication device 58, through the resistor network comprised of resistors R5 and R6, to pull the BIT signal high at pin 3 of connector J1. Upon disengagement of test switch SW1, MOSFET Q4A and Q5A will turn off in accordance with the respective time delay components, and subsequently turn off MOSFET Q5A and Q5B, returning communication device 58 to a no power mode.

Capacitive sensing alarm circuit 60 also provides inputs to wireless communication device 58 relating to the voltage level of battery 56. Still-alive timer 94 monitors battery 56, for example by periodically measuring battery V_{CC}. If the available supply V_{CC} is sufficient for operation of alarm circuit 60 and communication device 58, still-alive timer 94 will drive MOSFET Q4A and Q5A, through diode D3. The signal is provided through resistor R13 and across capacitor C7 and resistor R14 to pin 4 of connector J1, thus providing modem supply V_{CC} to communications device 58 and indicating that sensor module 22 is still functional.

Battery low sensor 96 monitors battery 56. If battery supply V_{CC} drops below a predetermined level which indicates that battery 56 power will soon be incapable of monitoring the liquid level on probe 70 or of transmitting messages to processing system 28, activation of the output of battery low sensor 96 occurs. Battery low sensor drives MOSFET Q4A and Q5A through diode D4. Communication device 58 is thereby powered by modem supply V_{CC} and is then able to monitor the level of modem supply Vcc, which reflects battery 56 charge, and to accordingly transmit a message to processing system 28.

Still-alive timer 94 is powered by battery 56 and, upon a predetermined timer interval, produces an output signal indicating that sensor module 22 is still sufficiently powered and remains operational. Activation of the output of still-alive 94 drives MOSFET Q4A and Q45 through diode D3, and pin 4 of connector J1 is driven high through resistor R13 and across resistor R14 and capacitor C7. Communication device 58 is thereby powered by modem supply V_{CC} and receives an indication on pin 4 that the periodic still-alive timer interval has been reached.

Various devisable portions of capacitive alarm sensing circuit 60 may be selectively included or excluded as desired for individual embodiments of sensor module 22. For example, an embodiment may exclude still-alive timer 94 and associated components. Additionally, other monitoring circuits may be included in an embodiment of sensor module 22, for example, a motion detector or other environmental sensor.

In the exemplary embodiment, wireless communication device 58 is advantageously an RF transceiver compatible with existing wireless network 26, which may be, for example, a cellular communications network. Additionally, communications device 58 includes processor and software application 59 for easy configuration and modification, including establishing various event messages and loading a sensor identifier code to be transmitted with event message 34. An exemplary wireless communication devices 58 are Part No. RIM 902M, available from Research In Motion, Waterloo, ON, Canada, and the devices disclosed by U.S. Pat. No. 5,619,531, issued Apr. 8, 1997; U.S. Pat. No. 5,727,020, issued Mar. 10, 1998; U.S. Pat. No. 5,764,693, issued Jun. 9, 1998; and U.S. Pat. No. 5,917,854, issued Jun. 29, 1999; all of which are titled “Wireless Radio Modem with Minimal Interdevice RF Interference,” the disclosures of which are hereby incorporated herein by reference.

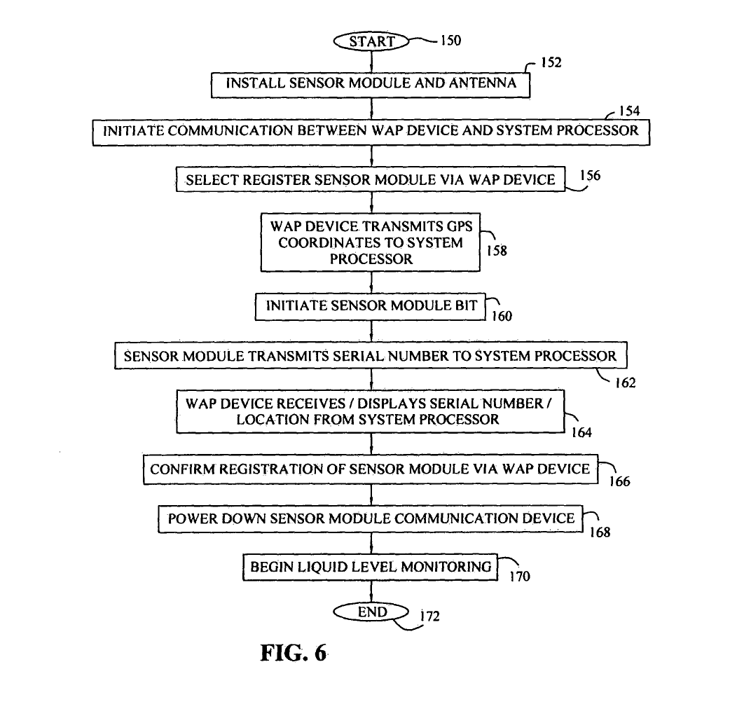

The method illustrated by the flowchart of FIG. 6 provides installation and registration of sensor module 22 with processing system 28, shown in FIG. 1. The method begins in step 150. In step 152, sensor module 22 and antenna 82 are physically installed at the desired location of wastewater handling system 31. In step 154, communication is initiated between WAP device 24 and system processor 154. The communication may be provided through existing communication network 26 and internet 46, for example, by accessing processing system 28 via web-enabled WAP device 24.

In step 156, once communication with processing system 28 is established, the installer selects registration of sensor module 22 in processing system 28 via WAP device 24. In step 158, WAP device 24 transmits GPS coordinates or other location information to system processor 28. For example, WAP device 24 may be GPS enabled and transmit the current GPS coordinates detected by WAP device 24, which is presently located in close proximity to installed sensor module 22.

In step 160, the installer initiates a built-in test (BIT) of sensor module 22 by pressing pushbutton switch SW1. In step 162, sensor module 22 transmits registration information including an identifying code, for example a serial number, to system processor 28. In step 164, system processor 28 receives and processes the registration information from sensor module 22 and transmits confirming information, such as serial number and location, to WAP device 24. In step 166, the installer confirms the registration of sensor module 22 with processing system 28 via WAP device 24.

In step 168, sensor module 22 is placed in a power-saving mode by powering down wireless communication device 58. The power-saving mode may be selected by sensor module 22 receiving confirmation of registration from processing system 28, or by the installer initiating a second BIT by pressing pushbutton SW1, or by another initiating event. In step 170, sensor module 22 begins liquid level monitoring and processing system 28 begins monitoring of communications from sensor module 22. The installation procedure is complete in step 172.

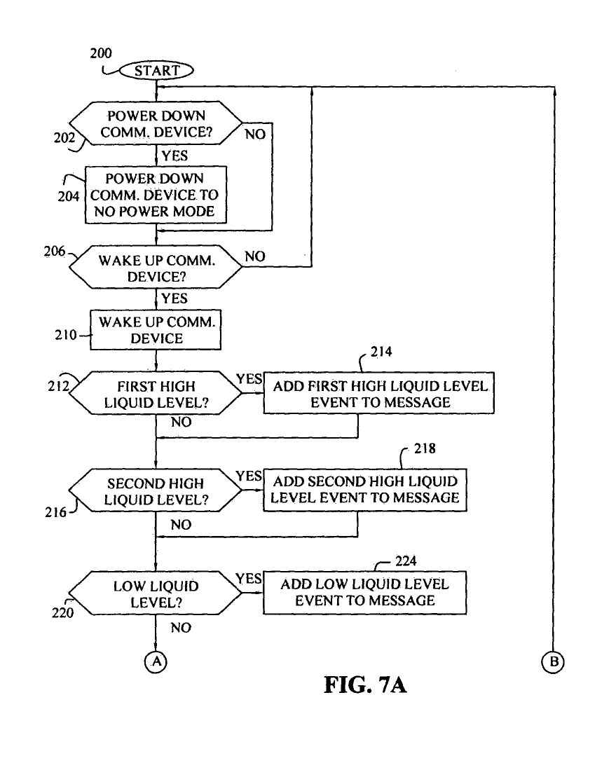

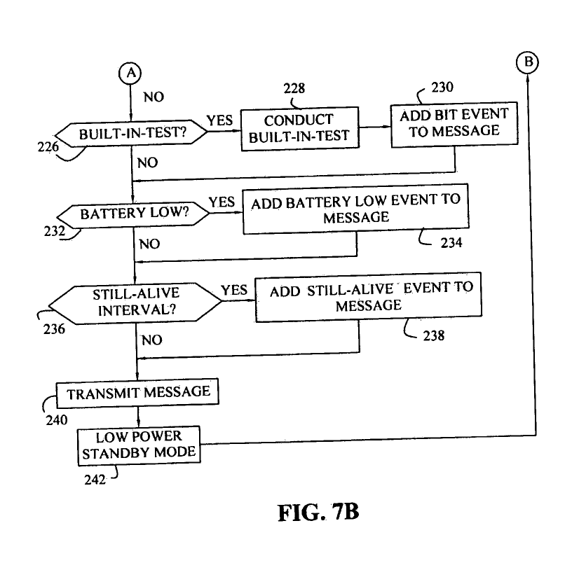

Referring to FIGS. 7A and 7B, the steps of the operation of wireless communications device 58 are illustrated by the flowchart. In the preferred embodiment, wireless communications device 28 is a wireless modem having processor and software 59. At least a portion of the illustrated steps are implemented by processor and software 59 and may be loaded into communication device 58 via serial programming port J4 (FIG. 5B) or by wireless transmission to communication device 58. Pins 2 and 3 of connector J4 provide transmit and receive and pin 16 of J1 provides active low Request to Send and pin 19 of J1 provides active low Data Terminal Ready for a serial connection with communication device 58.

The operation of wireless communications device 58 begins in step 200 after sensor module 22 is registered with processing system 28. In step 202, alarm circuit 60 determines whether to cut off power to device 58. If so, step 204 is completed, else step 206 is completed. In step 204 device 58 is powered down to a no-power state. Advantageously, device 58 will remain in the no-power state until an event occurs that requires processing or a transmission of an event message to processing system 28. In step 206, processor 59 determines whether device 58 should be powered up from a low power standby state to the high power state for determination of an event and transmission of a message, for example, upon data controller 58b receiving modem supply Vcc from sensing circuit 60. If inputs from sensing circuit 60 are detected and require an event message, then in step 210 device 58 will be powered up, else operation loops back to step 202.

In step 212, processor 59 determines whether input pin 1 of connector J1 is active, indicating a first high liquid level is detected by alarm circuit 60. If so, in step 214 processor 59 adds a first high liquid level event to event message 34. In step 216, processor 59 determines whether input pin 2 of connector J1 is active, indicating a second high liquid level has been detected by sensing circuit 60. If so, in step 218 processor 59 adds a second high liquid level to the outgoing message. In step 220, processor 59 determines whether input pins 1 and 2 of connector J1 are not active, indicating a low liquid level event has been detected by alarm circuit 60. If so, in step 224, processor 59 adds a low liquid level event to event message 34.

In step 226 (FIG. 7B), processor 59 determines whether input pin 3 is active indicating a built-in test has been initiated by pressing pushbutton SW1. If so, in step 228, a built-in test is completed by communication device 58, else operation continues at step 232. In step 230, processor 59 adds a built-in test event to event message 34.

In step 232, processor 59 determines whether a low voltage for battery 56 has been detected by power/wake/sleep control 59b. If so, in step 234, processor 59 adds a battery-low event to event message 34, else operation continues at step 236.

In step 236, processor 59 determines whether pin 4 is active indicating still-alive timer 94 has reached the next timer. If the interval has been reached, in step 238, processor 59 adds a still-alive event to event message 34, else operation continues at step 240.

In step 240, communication device 58 transmits event message 34 to communications network 26. In step 242, processor 59 returns communication device 58 to the low-power standby state. After step 242 is completed, operation loops to step 202 and the process is repeated.

Referring to FIG. 1, transmitted event message 34 is received by existing communications network 26. The exemplary communications networks includes, by way of example, satellite 38 and satellite receiver 40, or terrestrial antenna 36, network path 42, and network operations center 44. For example, the exemplary embodiment uses a Mobitex wireless network. Network operations center 44 of communications network 26 provides continuity with other communications networks, for example, Internet 46. Thus, network operation center 44 forwards event message 34 through Internet 46 to processing system 28. In order for communication device 58 to send event message 34 to processing system 28, typical wireless modem communications events may occur. For example, processing systems 28 or communication network 26 may transmit a ready to receive message to communication device 58.

Processing system 28 may be any type of data processor, for example, a Windows-based computer. Processing system 28 may also include database 29. In the exemplary embodiment, database 29 is used to register installation locations of sensor modules 22, indexing them by unique sensor identifiers and/or location. When event message 34 is received by processing system 28, the sensor identifier contained in event message 34 may be used to retrieve the installed location of sensor module 22 which transmitted event message 34. Processing system 28 also provides date and time stamping of events received in event messages 34. Processing system 28 may also utilize database 29 to store or retrieve event history or other information regarding sensor module 22 or wastewater handling system 31.

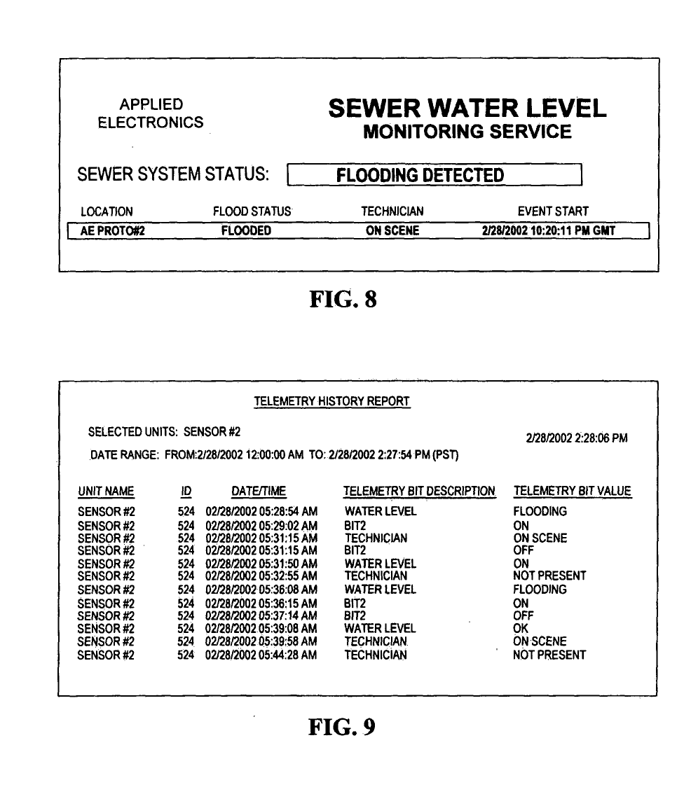

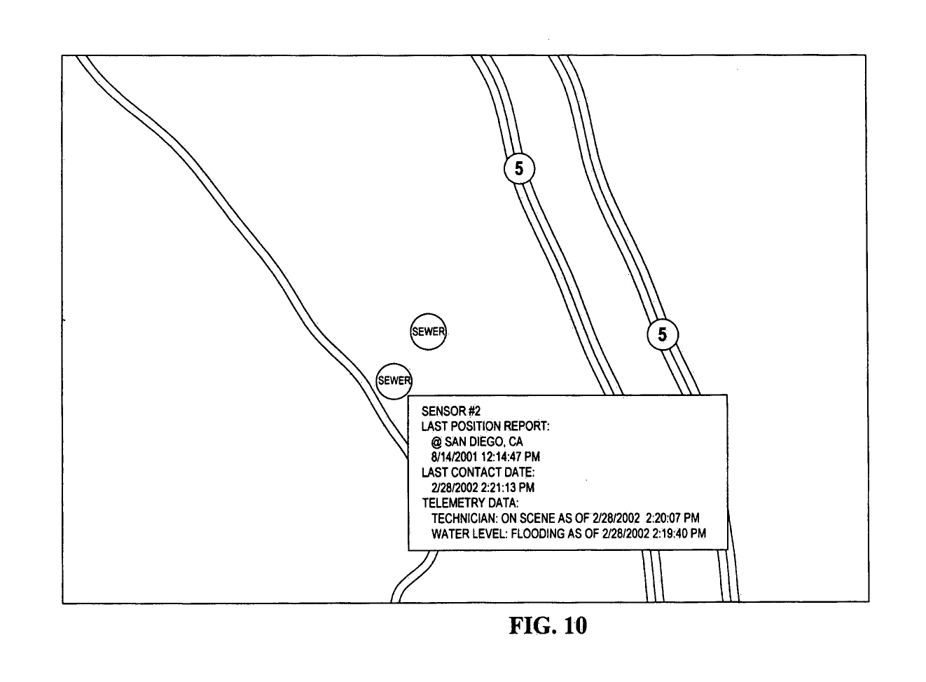

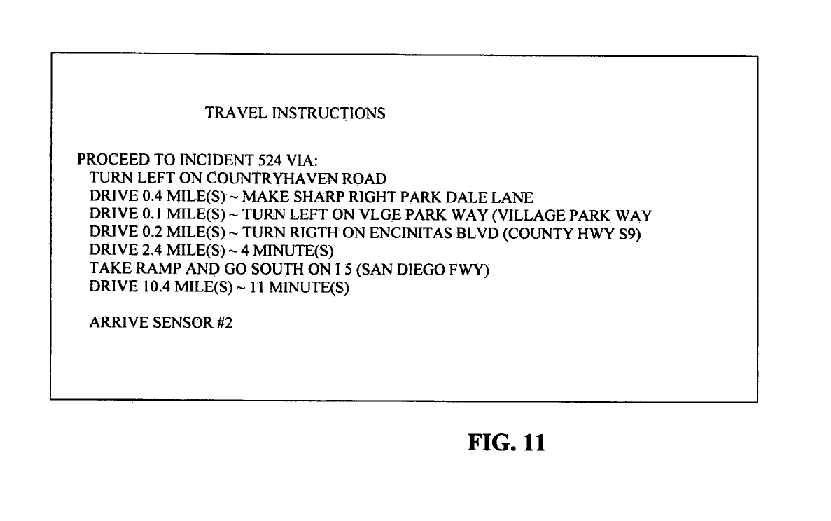

Processing system 28 may then provide a status and location report (FIG. 8) of sensor module 22, an event history report (FIG. 9), a map (FIG. 10) indicating the event location and status, travel directions (FIG. 11) to the event location and other such information, useful for monitoring and correcting conditions of wastewater handling system 31. Processing system 28 may provide this information in notification message 30 via a web page, as shown in FIGS. 8-11, e-mail, page, or by any other form of communication transmission. Exemplary processing system 28 is available from Cloudberry Wireless Services of San Diego, Calif., and ArcLocation™ Solutions, ERSI of Redlands, Calif.

Recipient 48 of notification message 30 may be a municipal operation center, maintenance dispatch center, emergency management center, or the like, who monitor and/or respond to events of wastewater handling system 31.

Processing system 28 or communication device 58 may also provide other tasks based on the events detected by sensor module 22. For example, by monitoring the elapsed time between detecting a first high liquid level and detecting the initiation or terminating of a second high liquid level or low liquid level, the rate of change of the liquid level in wastewater handling system 31 may be determined, or predicted time for flooding of manhole cover 32 may be predicted. Additionally, recording of the use of WAP device 24 at sensor module 22 or initiation of a built-in test can be used to document physical inspection of an event in accordance with Environmental Protection Agency regulations or other such compliance requirements.

While the exemplary embodiment provides remote monitoring of wastewater handling system 31, sensor module 22 and other elements of system 20 may be used for remote monitoring of other systems, locations, or events. For example, sensor module 22 may be installed in a basement or in an industrial location requiring liquid level or other such environmental monitoring.

The values of the circuit elements shown in FIGS. 5A and 5B are given below in Table 1:

TABLE 1

| ELEMENT | VALUE |
|---|---|
| R1 | 1K |
| R2 | 50K |
| R3 | 1M |
| R4 | 1M |
| R5 | 12K |
| R6 | 33K |
| R7 | 12K |
| R8 | 33K |
| R9 | 1M |
| R10 | 1M |
| R11 | 12K |
| R12 | 33K |
| R13 | 12K |
| R14 | 33K |
| R15 | 12K |
| R16 | 33K |
| C1 | 10 μf |
| C2 | 100 nf |
| C3 | 100 nf |
| C4 | 47 μf |
| C5 | 47 μf |
| C6 | 100 pf |
| C7 | 100 pf |
| C8 | 100 pf |
| C9 | 100 pf |
| U14 | QT114 Quantum |
| | Research Group |
| D1 | BAV99/SOT |
| D2 | Schottky Diode |
| D3 | Schottky Diode |
| D4 | Schottky Diode |
| Q4A, Q4B | MOSFET |
| | ZXMD63N02XTA |
| Q5A, Q5B | MOSFET |
| | ZXMD65P02N8TA |

The description of the circuit lines at connector J1, which couples capacitive sensing alarm circuit 60 to wireless communications device 58, are given below in Table 2.

TABLE 2

| PIN # | DESCRIPTION |
|---|---|
| 1, 2, 3, 4 | Bidirectional I/O lines |
| 7, 8 | Power |
| 9 | Ground |
| 10 | Turn Wireless Tx/Rx On |
| 16 | ˜Request To Send |
| 18 | Ground |
| 19 | ˜Data Terminal Ready |
| 20 | Transmit |
| 21 | Receive |

While this invention has been described as having exemplary embodiments and scenarios, the present invention can be further modified within the spirit and scope of this disclosure. This application is therefore intended to cover any variations, uses, or adaptations or the invention using its general principles. Further, this application is intended to cover such departures from the present disclosure as come within known or customary practice in the art to which this invention pertains and which fall within the limits of the appended claims.

What is claimed is:

1. A liquid level monitoring system for monitoring events in a wastewater or other liquid handling system, comprising:
a battery-powered sensor module capable of detecting liquid handling system events, said sensor module being associated with a segment of the liquid handling system;
said sensor module including a wireless communication device having a processor and associated software enabling said communication device to detect events and determine event messages relating to at least one of liquid level and sensor module status, said communication device capable of transmitting said event messages; and
a processing system receiving said event messages and producing and routing a notification message, said notification message including at least one of event location, identification of said segment, and event status.

2. The liquid level monitoring system of claim 1, wherein said module includes a capacitive probe and a capacitive sensing circuit electrically coupled to said capacitive probe and said communication device.

3. The liquid level monitoring system of claim 2, wherein said capacitive probe comprises a sensor wire encased by a dielectric material.

4. The liquid level monitoring system of claim 2, further comprising a wireless provider network receiving said event messages from said communication device and retransmitting said event messages to said processing system via a communications network.

5. The liquid level monitoring system of claim 4, wherein said communications network comprises the Internet and said wireless provider network comprises a cellular network.

6. The liquid level monitoring system of claim 2, wherein the liquid handling system includes a manhole cover assembly and said sensor module is mounted to the manhole cover assembly.

7. The liquid level monitoring system of claim 6, wherein said sensor module is mounted to an interior surface of the manhole cover assembly supporting ring.

8. The liquid level monitoring system of claim 7, wherein downward from said capacitive probe depends downward from the manhole cover assembly.

9. The liquid level monitoring system of claim 2, wherein said wireless communication device includes at least one of a conventional dipole antenna, a roadway embedded loop antenna, a composite manhole cover embedded antenna, and a manhole cover top mount antenna.

10. The liquid level monitoring system of claim 2, wherein said event message includes at least one of a high liquid event, a low liquid event, a built-in-test event, a battery low event, a still-alive event, a sensor module identifier, and a sensor module location.

11. The liquid level monitoring system of claim 2, wherein said notification message comprises at least one of a liquid handling system, a sensor module status, a status location map, a Webpage, an e-mail, a pager message, and a phone call.

12. The liquid level monitoring system of claim 2, wherein:
said processing system further comprises a database storing sensor module identifiers and installed sensor module locations, and
said event location is determined by correlating said sensor module identifier with said installed sensor module locations.

13. The liquid level monitoring system of claim 2, wherein said wireless communication device is in a low-power standby mode or no-power off mode until said sensing circuit activates said wireless communication device.

14. The liquid level monitoring system of claim 1, further comprising a wireless device having a GPS locator and capable of communicating with said processing system.

15. The liquid level monitoring system of claim 14, wherein said wireless device is web-enabled.

16. A battery-powered sensor module, comprising:
a probe;
a circuit having a detector connected to said probe and capable of detecting a high liquid level on said probe; and
a wireless communication device connected to said alarm circuit and having a processor and associated software enabling said communication device to determine event messages based on output of said circuit, said event messages relating to at least one of liquid level and sensor module status, said communication device capable of transmitting said event messages.

17. The sensor module of claim 16, wherein said communication device includes a low power standby state.

18. The sensor module of claim 16, wherein said circuit is capable of selectively powering said communication device.

19. The sensor module of claim 16, wherein said probe is a capacitive probe.

20. The sensor module of claim 19, wherein the module is mounted to a manhole cover or cover ring; and said capacitive probe depends downwardly from said module into a space below said manhole cover.

21. The sensor module of claim 19, wherein said capacitive probe comprises a wire having a dielectric covering.

22. The sensor module of claim 16, wherein said wireless communication device includes at least one of a conventional dipole antenna, a roadway embedded loop antenna, a composite manhole cover embedded antenna, and a manhole cover top mount antenna.

23. The sensor module of claim 16, wherein said event message includes at least one of a high liquid event, a low liquid event, a built-in-test event, a battery low event, a still-alive event, a sensor module identifier, and a sensor module location.

24. The sensor module of claim 16, wherein said circuit comprises a timer for periodically activating said communication device.

25. The sensor module of claim 16, wherein said circuit comprises a sensor capable of detecting a low battery and activating said communication device.

26. The sensor module of claim 16, wherein said circuit comprises components for initiating a built-in test of the sensor module and capable of activating said communication device.

27. The sensor module of claim 16, wherein said circuit is capable of disconnecting power from said communication device upon said detector detecting a low liquid level.

28. The sensor module of claim 16, wherein said communication device is capable of transmitting said event messages to at least one of a CDMA, TDMA, and GSM based wireless network.

29. A method of monitoring the liquid level of a wastewater handling system comprising the steps of:
installing a sensor module in a segment of the wastewater handling systems, the sensor module having a wireless communication device and a sensor circuit;
registering the sensor module location and identification code in a processing system;
activating power to the communication device upon the sensor circuit detecting a first high liquid level; and
transmitting an event message including the sensor module identification code from the communication device to the processing system.

30. The method of claim 29, further comprising transmitting a notification message from the processing system to a notification recipient upon receipt of an event message.

31. The method of claim 29, wherein said step of registering the sensor module includes transmitting to the processing system the location of the sensor module from a wireless device equipped with a GPS locator.

32. The method of claim 29, further comprising disabling power to the communication device upon the sensor circuit no longer detecting a first high liquid level.

33. The method of claim 32, wherein the step of disabling power includes transmitting an event message from the communication device before disabling power.

34. The method of claim 29, further comprising activating the communication device and transmitting an event message upon detecting a low battery level.

35. The method of claim 29, further comprising transmitting an event message upon detecting a second high liquid level.

36. The method of claim 29, further comprising switching the communication device to a low power standby state upon completion of transmitting an event message.

37. The method of claim 29, further comprising activating the communication device and transmitting an event message on a predetermined periodic basis.
